(19) United States
(12) Patent Application Publication
(10) Pub. No.: US 2011/0148708 A1
(43) Pub. Date: Jun. 23, 2011

(54) METHOD FOR ACCURACY IMPROVEMENT OF TIME MEASUREMENT AND POSITION TRACKING APPARATUS USING THE SAME

(75) Inventor: Seung Il MYONG, Daejeon (KR)

(73) Assignee: Electronics and Telecommunications Research Institute, Daejeon (KR)

(21) Appl. No.: 12/887,016

(22) Filed: Sep. 21, 2010

(30) Foreign Application Priority Data
Dec. 18, 2009 (KR) 10-2009-0127347
Mar. 25, 2010 (KR) 10-2010-0026838

(51) Int. Cl. G01S 3/16; G04C 11/02

(52) U.S. Cl. 342/378; 368/47

(57) ABSTRACT

Disclosed is a method for improving accuracy of time measurement and a position tracking apparatus using the same. A method for improving accuracy of time measurement includes receiving a radio communication signal and obtaining timing information in a received signal; tracking a code that detects inconsistent timing between the received signal and a tracking signal generated for the received signal; storing history information on the inconsistent timing between the received signal and the tracking signal for each bit of the received signal; and arithmetically averaging the history information and updating the timing information of the received signal with the arithmetically averaged value.

### CROSS-REFERENCE TO RELATED APPLICATIONS

This application claims priority under 35 U.S.C. §119 to Korean Patent Application No. 10-2009-0127347, filed on Dec. 18, 2009, and Korean Patent Application No. 10-2010-0026838, filed on Mar. 25, 2010, in the Korean intellectual Property Office, the disclosure of which is incorporated herein by reference in its entirety.

### BACKGROUND OF THE INVENTION

1. Field of the Invention

The present invention relates to a position tracking technology, and more particularly, to a method for improving accuracy of time measurement and a position tracking apparatus using the same.

2. Description of the Related Art

Recently, with the development of a mobile telecommunication technology, research and development on a positioning technology that provides new services by capturing a position of a user have been prevalently made. Generally, service fields using position information are referred to as a location-based service (LBS), a real time locating system (RTLS), etc.

As a method for obtaining position information, there are a typical method using a global positioning system (GPS), a method using a mobile telecommunication terminal based on a mobile telecommunication technology such as code division multiple access (CDMA) or global system for mobile communications (GSM), a method of combining a GPS and an inertial navigation system (INS), a method of combining a GPS and a mobile telecommunication terminal, a method of combining a GPS/mobile telecommunication terminal/INS, etc. Recently, positioning methods using radio-frequency identification (REID), Wi-Fi (IEEE 802.11b), Zigbee (IEEE 802.15.4), ultra-wide band (UWB), Bluetooth, wireless LNA technologies, etc. have been actively researched.

### SUMMARY OF THE INVENTION

It is an object of the present invention to provide a method for improving accuracy of time measurement capable of improving accuracy of code tracking by measuring an arrival time of radio communication signals and recalculating the arrival time of the radio communication signal through historical information on code tracking in a tracking system having time synchronization.

It is another object of the present invention to provide a position tracking apparatus capable of more accurately performing position calculation in real time by using a method for improving accuracy of time measurement.

In order to achieve the above technical problems, according to an aspect embodiment of the present invention, there is provided a method for improving accuracy of time measurement in an apparatus receiving radio signals, including: obtaining timing information in a received signal; tracking a code that detects inconsistent timing between the received signal and a tracking signal generated for the received signal; storing history information on the inconsistent timing between the received signal and the tracking signal for each bit of the received signal; and arithmetically averaging the history information and correcting or updating the timing information of the received signal with the arithmetic average.

The history information includes the last history information for each bit of the received signal.

The tracking the code may include comparing the difference between the last history information on the code tracking of the current bit with the last history information on the code tracking of just the previous bit while code tracking for each bit of the received signal.

The method for improving accuracy of time measurement may further include calculating the number of history information results subjected to the comparing.

The updating may update the timing information with a value rounding off a decimal point or less of the arithmetically averaged value.

The tracking signal may include an early signal, a late signal, or both of them. In this case, the updating may include updating the timing information with a value approaching the timing information among the results obtained by performing the code tracking using the early signal and the results obtained by performing the code tracking using the late signal.

According to another aspect embodiment of the present invention, there is provided a position tracking apparatus, including: a sampling unit that obtains timing information in a received signal; a tracking signal generator that generates a tracking signal; a correlator that detects the timing error between the received signal and the tracking signal; a storage unit that stores history information on the timing error between the received signal and the tracking signal for each bit of the received signal; and an accumulated average calculator that obtains the arithmetic average for the history information and outputs the arithmetically averaged results in order to correct or update the timing information.

The position tracking apparatus may further include a sampling position controller that controls a sampling position according to an output signal for the timing error of the correlator. In addition, the position tracking apparatus may further include a timing information storage unit that stores the timing information.

The history information includes the last history information generated in tracking a code for each bit of the received signal.

The correlator may compare the difference between the last history information on the code tracking of the current bit with the last history information on the code tracking of just the previous bit while code tracking for each bit of the received signal. The storage unit may store the history information results when an absolute value of the difference between the last history information is larger than 1. The accumulated average calculator may arithmetically average the number of history information results.

The timing information may be updated with a value rounding off the decimal point or less of a value obtained by the arithmetic average. In this case, the tracking signal includes an early signal, a late signal, or both of them. The timing information may be updated with a value approaching the timing information among the results obtained by performing the code tracking using the early signal and the results obtained by performing the code tracking using the late signal.

According to an exemplary embodiment of the present invention, it performs an arithmetic average on the historical information of the code tracking results and updates the arithmetically averaged value at the arrival time of the radio signals. In other words, it recalculates the accuracy of the code tracking in the position tracking system having time synchronization. Therefore, it can improve the performance of the position tracking apparatus by improving the accuracy of the arrival time of the radio signals and more accurately perform the position calculation in real time. In addition, it can efficiently reduce the timing error in the real time locating system (RTLS), etc.

### BRIEF DESCRIPTION OF THE DRAWINGS

FIG. 1 is a diagram for explaining a difference in arrival times of received signals in a method for improving accuracy of time measurement according to an exemplary embodiment of the present invention;

FIG. 2 is a diagram for explaining a process of tracking inconsistent information between spread codes of the received signals having the difference in the arrival time of FIG. 1;

FIG. 3 is a diagram for explaining code tracking results in a method for improving accuracy of time measurement according to an exemplary embodiment of the present invention;

FIG. 4 is a flow chart of the method for improving accuracy of time measurement according to an exemplary embodiment of the present invention; and

FIG. 5 is a schematic configuration diagram of a position tracking apparatus according to an exemplary embodiment of the present invention.

### DETAILED DESCRIPTION OF THE PREFERRED EMBODIMENTS

Hereinafter, exemplary embodiments of the present invention will be described in detail with reference to the accompanying drawings and contents to be described below. Therefore, the present invention may be modified in many different forms and it should not be limited to the embodiments set forth herein. Rather, the exemplary embodiments set forth herein are provided to a person of ordinary skill in the art to thoroughly and completely understand contents disclosed herein and fully provide the spirit of the present invention. Like reference numerals designate like components throughout the specification. Meanwhile, terms used in the present invention are to explain exemplary embodiments rather than limit the present invention. In the specification, a singular type may also be used as a plural type unless stated specifically. “Comprises” and/or “comprising” used herein does not exclude the existence or addition of one or more other components, steps, operations and/or elements.

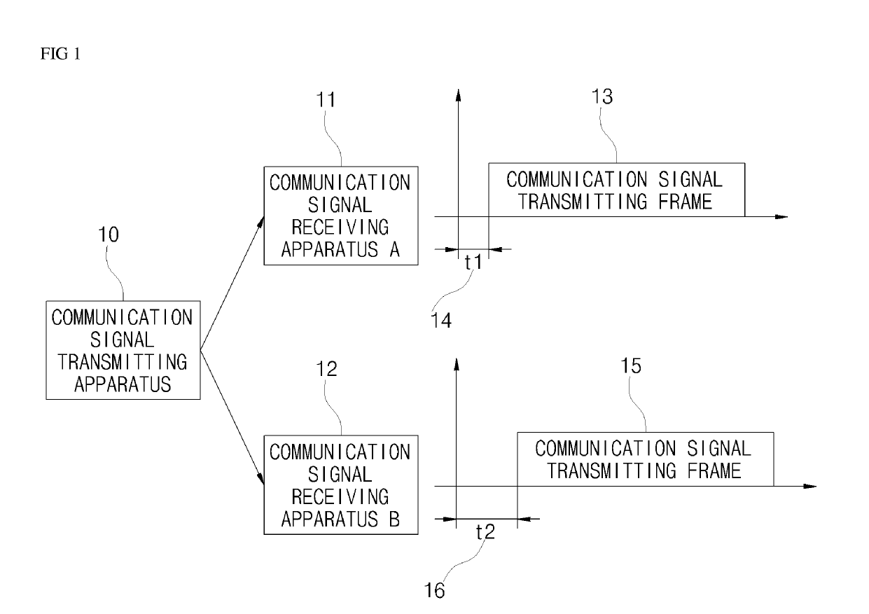

FIG. 1 is a diagram for explaining a difference in arrival times of received signals in a method for improving accuracy of time measurement according to an exemplary embodiment of the present invention.

FIG. 1 shows a relationship between communication signals received in an apparatus 11 for receiving communication signals A (hereinafter, referred to as a first receiving apparatus) and an apparatus 12 for receiving communication signals B (hereinafter, referred to as a second receiving apparatus), which are synchronized with an apparatus 10 for transmitting communication signals.

The arrival timing information 14 of a communication signal transmitting frame 13 (hereafter, referred to as a first communication signal) received in the first receiving apparatus 11 is t1, and the arrival timing information 16 of a communication signal transmitting frame 14 (hereinafter, referred to as a second communication signal) received in the second receiving apparatus 12 is t2.

The difference in time between two receiving apparatuses 11 and 12 is |t1−t2|. This difference is an important factor to calculate a position.

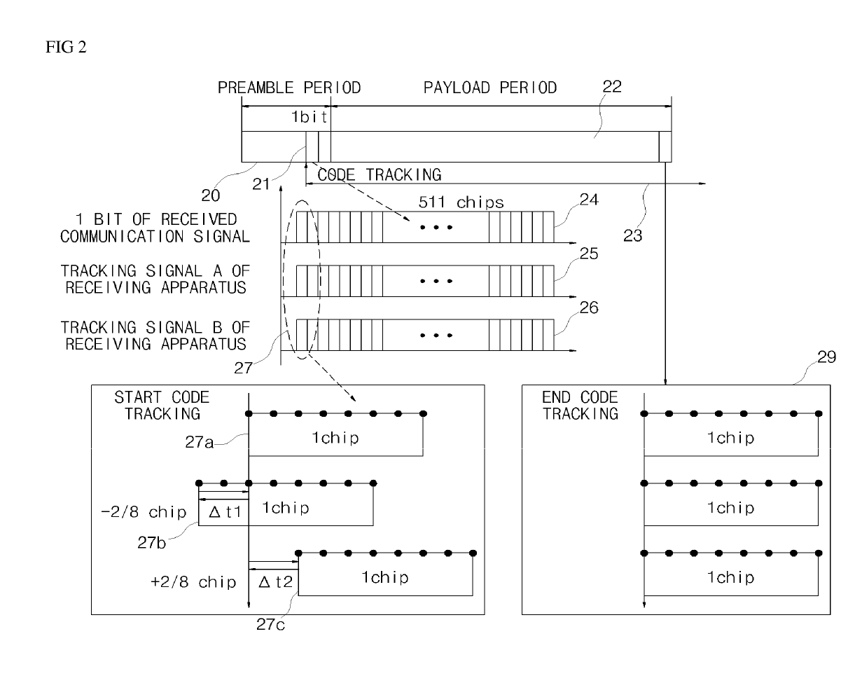

FIG. 2 is a diagram for explaining a process of tracking inconsistent information between spread codes of the received signals having the difference in the arrival time of FIG. 1.

Referring to FIG. 2, the accuracy of a value of |t1−t2| is determined by timing resolution used.

A method for measuring the arrival time by code tracking acquires the timing information by determining the inconsistent degree between spread codes included in each bit of received signals including a preamble period 20 and a payload period 22 and spread codes in each of the receiving apparatuses 11 and 12. In other words, each code having inconsistent degree between the spread codes of the received communication signals 24 (hereinafter, referred to as received signals) and code generating signals 25 and 26 to be compared in each of the receiving apparatuses 11 and 12 can be determined based on the received signal code 27a (hereinafter, referred to as received code).

For example, FIG. 2 shows an enlarged diagram of a start portion 27 of each code of the received signal and the tracking signal. The signal 27b (tracking signal A) in the first receiving apparatus 11 may be inconsistent since its code deviates by a − 2/8 chip unit, that is, Δt1 based on the receiving code 27a and the signal 27c in the second receiving apparatus 12 (tracking signal B) may be inconsistent since its code deviates by a + 2/8 chip unit, that is, Δt2 based on the receiving code 27a.

At this time, when performing the code tracking up to the end of the frame of the receive signal 24, the code of the received signals can be accurately tracked when the code tracking ends, as shown in the lower right box 29 of FIG. 2. It can appreciate the inconsistent degree at the time the code starts by storing the code tracking history during performing the code tracking.

Meanwhile, the resolution of the code tracking is limited to a clock of each receiving apparatus, that is, a sampling rate in each receiving apparatus. In other words, since one example shown in FIG. 2 has the sampling rate of eight times for 1 chip in the code tracking, the sampling rate becomes the limit of the resolution in measuring time using the code tracking. If the code inconsistent degree exists between 2/8 chip and ⅜ chip, the code tracking results become 2/8 chip or ⅜ chip. In this case, the position measuring error corresponding to the inconsistent error of ⅛ chip may occur in the position measuring apparatus or method.

Therefore, the present invention proposes a method for improving accuracy of calculation and the position tracking apparatus using the same in order to more accurately measure and correct time than the resolution of the receiving apparatus in the system for tracking position using the code tracking results.

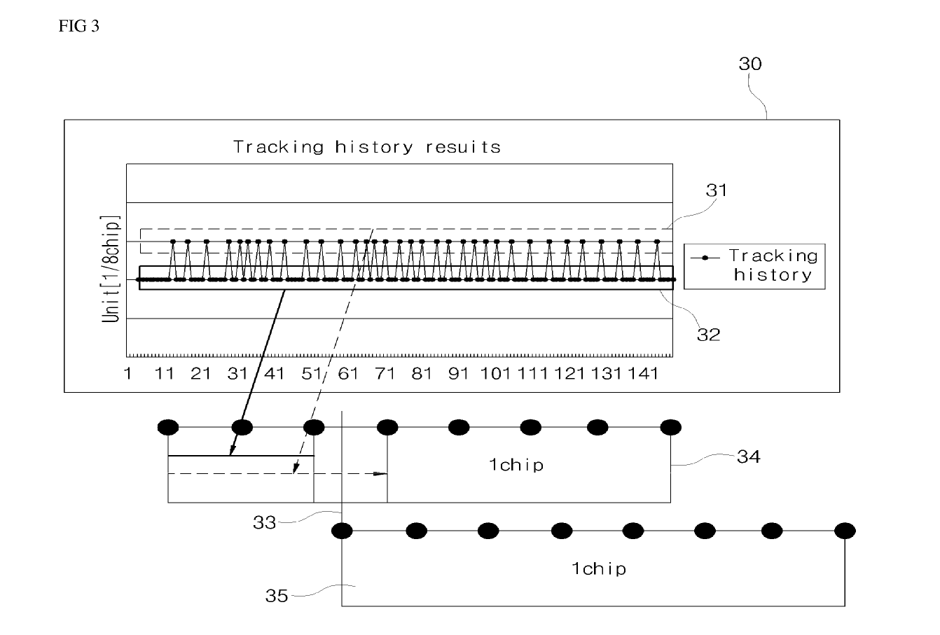

FIG. 3 is a diagram for explaining code tracking results in a method for improving accuracy of time measurement according to an exemplary embodiment of the present invention,

As shown in FIG. 3, a 1 chip unit of the code (receiving code) included in 1 bit of the received signal is 35 and a 1 chip unit of the code (tracking code) included in 1 bit to be compared in the first or second receiving apparatus is 34.

When being compared at the start time of the code tracking, if it is assumed that the inconsistent degree deviates by 2/8 chip, +¼ chip*⅛ chip, it can be appreciated that the code inconsistent degree exists between 2/8 chip and ⅜ chip but approaches 2/8 chip.

The tracking history results through the code tracking for each bit until the received signal frame ends are equal to a graph 30 shown in FIG. 3.

It shows that the history results tracking from the fourth tracking results to the last tracking results tends to be dense between 2/8 chip and ⅜ chip. The timing inconsistent degree can be determined from this tendency. In the present embodiment, the number determined to be ⅜ chip is 34 and the number determined to be 2/8 chip is 108. When performing the arithmetic average on the determined number by a total number of bits, this depends on the following Equation 1.

Arithmetic average=(3×34+2×108)/142=about 2.24 [Equation 1]

In other words, the results approaching 2/8 chip can be obtained.

Meanwhile, in the case of performing the measurement using only the code tracking results in ⅛ chip unit, when the code tracking result is determined as 2, the error of about 0.24 is shown and when the code tracking result is determined as 3, the code tracking error of about 0.76 can be generated. Therefore, when using the method of measuring time according to the present invention, the error can be reduced by the code tracking due to the resolution limitation of the receiving apparatus itself.

As described above, according to the exemplary embodiment, the system limitation of the time measurement using the code tracking results can be overcome by the correction method. Hereinafter, the method for measuring time and the position tracking apparatus using the same according to the exemplary embodiment will be described in more detail.

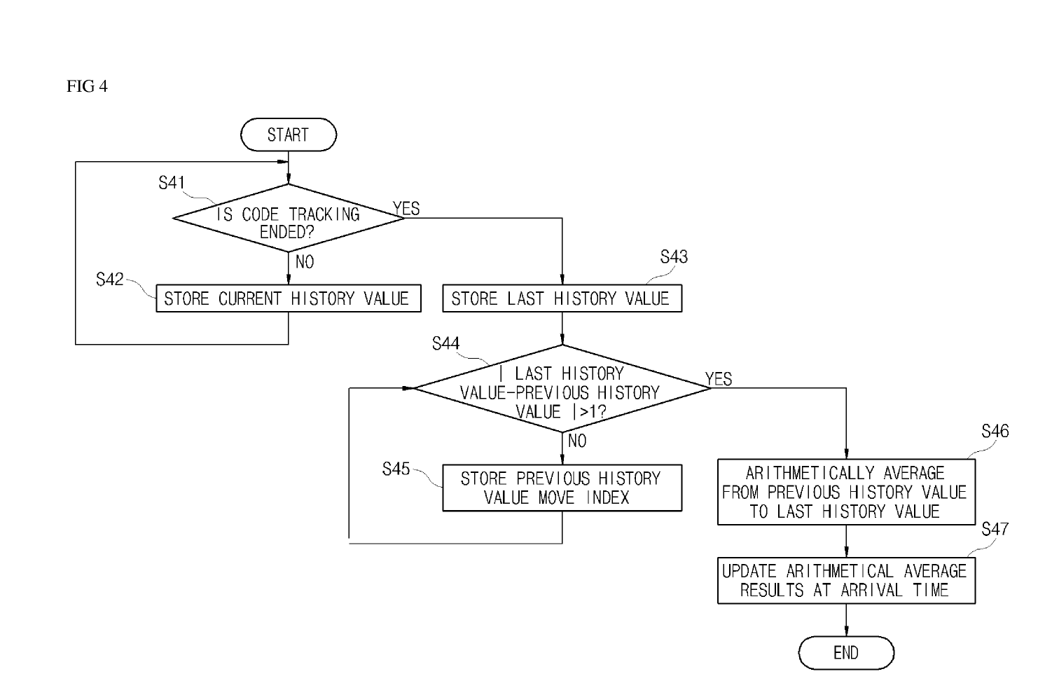

FIG. 4 is a flow chart of the method for improving accuracy of time measurement according to an exemplary embodiment of the present invention.

Referring to FIG. 4, when the code tracking for the received signal starts, it is first determined whether the code tracking for the spread code ends in each bit of the received signal (S41).

When the code tracking does not end, the current history value is stored (S42). It continuously maintains or repeats the code tracking up to the end of the frame of the received signal.

Next, when the code tracking ends, it stores the last history value (S43). It compares the last history value with the last history value of the previous code tracking (S44). For example, it is determined that the absolute value of a value subtracting the previous history value from the last history value is larger than 1. When the absolute value is not larger than 1, it stores the previous history value and repeatedly performs the comparison by moving an index (S45). In other words, in performing the code tracking to determine the received code, since the resolution is ⅛, if the difference in the previous history value compared with the last stored value exists below ⅛ chip, it continuously perform the comparison at the determination step (S44).

If the difference between the last stored history value and the previous history value is ⅛ chip or more, it obtains the arithmetic average by including the history information stored as the previous history value and the history information before exceeding ⅛ in the arithmetic average (S46). It updates the calculated arithmetic average results at the arrival time (S47).

According to the exemplary embodiment, it arithmetically averages the code tracking results of the transmitted signals and the received signals and updates them at the arrival timing information, thereby making it possible to accurately measure the code inconsistent degree. In other words, the limiting factor of the position tracking system, the resolution, can be improved in a software manner.

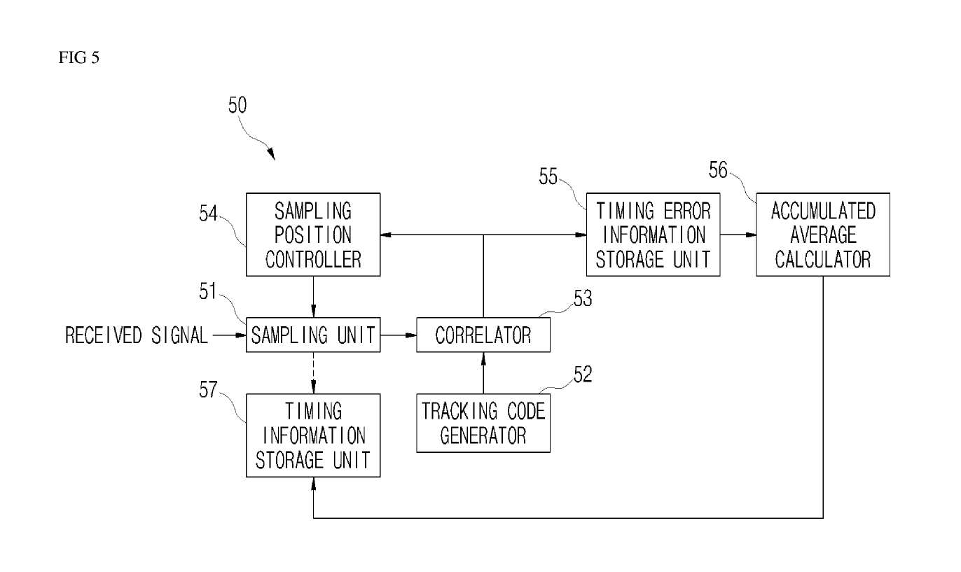

FIG. 5 is a schematic configuration diagram of a position tracking apparatus according to an exemplary embodiment of the present invention.

The position tracking apparatus according to the exemplary embodiment includes units for accurately measuring the code inconsistent degree by obtaining the timing information from the transmitted signal received from the communication signal transmitting apparatus and arithmetically averaging the code tracking results for the transmitted signal and the received signal to recalculate the timing information. The transmitted signal corresponds to the above-mentioned received signal with reference to FIGS. 1 to 4 and the received signal corresponds to the tracking signal.

In the exemplary embodiment, the unit for measuring the code inconsistent degree uses the history information in order to measure the inconsistent degree. The unit for calculating the inconsistent degree includes a unit for comparing the difference between the last history information and the previous history information through the comparing unit, a unit for calculating the total number of history information, and a unit for performing the arithmetic average from the calculating unit. The unit for performing the arithmetic average includes the unit for calculating the error of timing information.

The structure of the position tracking apparatus according to the exemplary embodiment will be described in more detail with reference to FIG. 5. The position tracking apparatus 50 includes a sampling unit 51, a tracking code generator 52, a correlator 53, a timing error information storage unit 54, a sampling position controller 55, an accumulated average calculator 56, and a timing information storage unit 57.

The sampling unit 51 samples the received signals to extract the timing information and extracts the spread code included in each bit of the received signal in order to perform the code tracking. The extracted timing information may be stored in the timing information storage unit 57. The extracted spread code is transmitted to the correlator 53.

The tracking code generator 52 generates codes to measure the arrival time of the received signal in a code tracking manner. The tracking code generated in the tracking code generator 52 is transmitted to the correlator 53.

The correlator 53 is a timing error detector, which detects the difference between the value of the history information on the timing inconsistency and the value of the previous or last history information at the current bit. The correlator 53 may use a decision aided algorithm timing recovery manner using data determined according to the used algorithm and a non-decision aided algorithm timing recovery manner not using the determined data. The determined data is referred to as data obtained by being mapped to the previously defined determined value obtained in the received signal and may be equal to and different from the data transmitted in the transmitting apparatus.

The sampling position controller 55 controls the sampling position of the received signal in response to the timing error signal detected in the correlator 53. The timing error signal may function as the control signal of the sampling position controller 55. The sampling position controller 55 includes a structure and function similar to the so-called interpolator/decimator module.

A loop filter may be positioned between the correlator 53 and the sampling position controller 55 in order to prevent the sudden change in the sampling position. The loop filter may be implemented as a kind of a low pass filter.

The timing error information storage unit 54 (hereinafter, referred to as a storage unit) stores the timing error information detected in the correlator 53. The timing error information includes a current history value, a last history value, and a previous history value. The history corresponds to the history information.

In addition, the storage unit 54 stores the history value in the case where the absolute value subtracting the previous history value from the last history value is larger than 1.

The accumulated average calculator 56 obtains the arithmetic average from the previous history value stored in the storage unit 54 to the last history value. It outputs the arithmetic average results to update the timing information on the arrival time stored in the timing information storage unit 57.

In addition, the arithmetic average results output from the accumulated average calculator 56 may be a value including a decimal point or less. In this case, the value rounding off the decimal point or less may be transmitted to the timing information storage unit 57 as the arithmetic average result.

In addition, the arithmetic average results output from the accumulated average calculator 56 may be prepared based on the history information of the code tracking results performed on an early signal and a late signal, respectively. The early signal and the late signal are the code generating signals, that is, the tracking signals generated in the receiving apparatus in order to perform the code tracking in response to the received signal. The early signal is referred to as the tracking signal (see 25 of FIG. 2) temporally earlier by a predetermined size than the received signal (see 24 of FIG. 2) and the late signal is referred to as the tracking signal (see 26 of FIG. 2) temporally later by the predetermined size than the received signal.

As described above, the timing information may be updated to a value approaching the timing information stored in the timing information storage unit 57 among the results obtained by performing the code tracking the received signal using the early signal and the results obtained by performing the code tracking using the late signal.

According to the exemplary embodiments, the position tracking apparatus can perform the time measurement and correction more accurately than its own timing resolution, while exceeding the timing resolution used in the position tracking apparatus.

The exemplary embodiment of the present invention is disclosed with reference to the detailed description and the drawings. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method for improving accuracy of time measurement in an apparatus receiving radio signals, comprising:
obtaining timing information in a received signal;
tracking a code that detects inconsistent timing between the received signal and a tracking signal generated for the received signal;
storing history information on the inconsistent timing between the received signal and the tracking signal for each bit of the received signal; and
arithmetically averaging the history information and updating the timing information of the received signal with the arithmetically averaged value.

2. The method of claim 1, wherein the history information includes the last history information for each bit of the received signal.

3. The method of claim 2, wherein the tracking of the code further includes comparing the difference between the last history information on code tracking of the current bit with the last history information on the code tracking of just previous bits while code tracking for each bit of the received signal.

4. The method of claim 3, further comprising calculating the number of history information subjected to the comparing.

5. The method of claim 4, wherein the updating includes updating the timing information with a value rounding off a decimal point or less of the arithmetically averaged value.

6. The method of claim 1, wherein the tracking signal includes an early signal, a late signal, or both of them.

7. The method of claim 6, wherein the updating includes updating the timing information with a value approaching the timing information among the results obtained by performing the code tracking using the early signal and the results obtained by performing the code tracking using the late signal.

8. A position tracking apparatus, comprising:
a sampling unit that obtains timing information in a received signal;
a tracking signal generator that generates a tracking signal;
a correlator that detects the timing error between the received signal and the tracking signal;
a storage unit that stores history information on the timing error between the received signal and the tracking signal for each bit of the received signal; and
an accumulated average calculator that obtains the arithmetic average for the history information and outputs the arithmetically averaged results in order to update the timing information.

9. The apparatus of claim 8, further comprising a sampling position controller that controls a sampling position according to an output signal for the timing error of the correlator.

10. The apparatus of claim 8, further comprising a timing information storage unit that stores the timing information.

11. The apparatus of claim 8, wherein the history information include the last history information generated in tracking a code for each bit of the received signal.

12. The apparatus of claim 8, wherein the correlator compares the difference between the last history information on the code tracking of the current bit with the last history information on the code tracking of just the previous bit while code tracking for each bit of the received signal.

13. The apparatus of claim 12, wherein the storage unit stores the history information results when an absolute value of the difference between the last history information is larger than 1.

14. The apparatus of claim 13, wherein the accumulated average calculator arithmetically averages the number of history information results.

15. The apparatus of claim 14, wherein the timing information is updated with a value rounding off the decimal point or less of a value obtained by the arithmetic average.

16. The apparatus of claim 8, wherein the tracking signal includes an early signal, a late signal, or both of them.

17. The apparatus of claim 8, wherein the timing information is updated with a value approaching the timing information among the results obtained by performing the code tracking using the early signal and the results obtained by performing the code tracking using the late signal.
